(19) United States
(12) Patent Application Publication
(10) Pub. No.: US 2010/0279260 A1
(43) Pub. Date: Nov. 4, 2010

(54) Method of Constructing Questions For Lie Detection Examinations

(76) Inventor: Bruce Alan White, Houston, TX (US)

Correspondence Address: Law Offices of Tim Headley, 7941 Katy Fwy, Suite 506, Houston, TX, 77024-1924, US

(21) Appl. No.: 12/772,490

(22) Filed: May 3, 2010

Related U.S. Application Data
(60) Provisional application No. 61/175,033, filed on May 3, 2009.

(51) Int. Cl. G09B 19/00

(52) U.S. Cl. 434/236

(57) ABSTRACT

A method for improving the construction of a polygraph examiner's question list during a computerized polygraph exam includes the following steps: a) before the polygraph exam, building a first library of different sequences of question types, and building a second library of different question types; b) organizing the first and second libraries; c) combining the different question types into sets of categories; d) selecting a sequence of question types from the first library, and selecting a first category of question types; e) reviewing a range of questions within the first category; f) selecting and adding some of the questions within the first category to the selected sequence of question types; g) during the polygraph exam, selecting a second category; h) repeating steps (e) and (f) for the second category; and i) repeating steps (g) and (h) until the polygraph examiner's question list is complete.

### CROSS-REFERENCES TO RELATED APPLICATIONS

This patent application claims the benefit of provisional patent application no. 61175033, filed on May 3, 2009, which is incorporated by reference in its entirety.

### STATEMENT REGARDING FEDERALLY SPONSORED RESEARCH OR DEVELOPMENT

None.

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC

None.

### BACKGROUND OF THE INVENTION

(1) Field of the Invention

This invention relates generally to lie detection methods.

(2) Description of the Related Art

U.S. Published Patent Application Nos. 20050119547 and 20090221930, which are incorporated by reference in their entirety, disclose the use of control questions, including truthful control questions and deceptive control questions, to provide bases for comparison for responses to stimuli of interest or questions of interest.

U.S. Pat. No. 7,565,193, which is incorporated by reference in its entirety, discloses a method of using control questions, including truthful control questions and deceptive control questions, to provide bases for comparison for responses to stimuli of interest or questions of interest.

U.S. Pat. No. 5,327,899, which is incorporated by reference in its entirety, discloses a method of using a series of control, relevant, and irrelevant questions.

Generally speaking, all polygraph examinations are classified in two ways: the sequence of questions, and the types of questions. Historically, the polygraph industry has developed numerous question type sequences. As an example, a popular exam method is called ZCT. This sequence has a defined skeleton structure to be filled in later with properly-worded question types.

The question types include irrelevant, outside issue, relevant, and probable-lie. Probable-lie questions in polygraph exams are necessary reference points to compare to the actual issue for which a polygraph exam is being given. The probable lie question type is especially demanding of a polygraph examiner's skill in selecting a comparison question that properly matches the type of wording related to the relevant question type. Selecting proper probable-lie comparison questions for pedophiles, gang killings, embezzlers, drug users, corrupt politicians, spies, truckers, rapists, etc., require very different vocabularies and mindsets. The probable-lie questions are the most difficult to design, because they must be designed to reflect many different variables, such as testing issues, subculture language and concepts, and specialized terms. The result is that polygraph examiners in the past usually spend a significant amount of time designing well-worded questions for probable lies for different individuals.

It would be useful for polygraph examiners to have a reference list of comparison (i.e., probable-lie) questions that are related to: a) the issue being tested, b) the subculture of the person being tested; and c) the vocabulary of the person being tested. What is needed is a method of quickly constructing questions during a computerized polygraph examination so that the examiner can focus on the polygraph subject, the art of interrogation, and reading body language. Accordingly, there is a need for an improved method of quickly constructing sequences of lie detection questions that improves question construction choices.

### BRIEF SUMMARY OF THE INVENTION

A method for improving the construction of a polygraph examiner's question list during a computerized polygraph exam includes the following steps: a) before the polygraph exam, building a first library of different sequences of question types, and building a second library of different question types; b) organizing the first and second libraries; c) combining the different question types into sets of categories; d) during the polygraph exam, selecting a sequence of question types from the first library, and selecting a first category of question types; e) reviewing a range of questions within the first category; f) selecting and adding some of the questions within the first category to the selected sequence of question types; g) selecting a second category; h) repeating steps (e) and (f) for the second category; and i) repeating steps (g) and (h) until the polygraph examiner's question list is complete.

In an alternate embodiment of the method, steps (g) through (i) occur only when the person being examined introduces unexpected information during the exam.

### DETAILED DESCRIPTION OF THE INVENTION

The method of the present invention for improving the construction of a polygraph examiner's question list during a computerized polygraph exam first includes, before the polygraph exam, building a first digital library of different sequences of question types, and building a second digital library of different question types. As an example, a popular exam method is called ZCT, with a sequence of X, IR1, IR2, SR, C4, R5, C6, R7, E8, C9, R10, XX. The sequence abbreviations (“labels”) have the following definitions:

| Label | Meaning | Example |
|---|---|---|
| R | Relevant, tests for a particular | “Did you rob the bank?” |
| | unknown state of lying | |
| C | Control, comparison, | “Have you ever lied to |
| | (“Probable-lie”) | someone who has trusted you?” |
| I | Irrelevant, informational, non- | “Are you now sitting in a |
| | stressful, emotionally neutral | chair?” |
| E or S | External, outside issue, | “Are you afraid that you |
| | symptomatic, tests to see if a | will be asked a question we |
| | subject is emotionally | have not discussed?” |
| | preoccupied with something | |

| | |
|---|---|
| X | Announce start by the examiner, does not require a response |
| | from the person being examined. |
| XX | Announce stop by the examiner, does not require a response |
| | from the person being examined. |

Other known sequences of question types are: ARMYZONE, ARTHER, BZONE, MGQT, MGQTTHF, TESS, UTAH3-1, UTAH3-2, UTAH3-3, ZONE COMPARISON, and ZONEYOU. The ARMYZONE has the following sequence of questions: X, 1 (“Are you sometimes called _?”), 2, E3, C4, R5, C6, R7, E8, C9, R11, R12, R13, XX. The ZONE COMPARISON has the following sequence of questions: X, 1, 2, E3, C4, R5, C6, R7, E8, C9, R10, XX.

The second step of the method of the present invention is organizing the first and second libraries. The third step of the method of the present invention is combining the different question types into sets of categories. Building the digital library of different question types is the most difficult part of the inventive method, specifically, building the library of the probable-lie questions. The categories of issues for probable-lie questions include at least the following categories: discuss-general, employment, espionage, gang killings, general, homicide, lie, neutral-irrelevant, politics, rape, robbery, sexual improprieties, sex crimes, stealing, and violence. Additionally, probable-lie questions also have to be developed for specific sub-cultures, including at least the following categories: adulterers, corrupt politicians, drug users, embezzlers, ethnicity, gangs, maritime, pedophiles, politicians, rapists, sexual addicts, spies, and truckers.

The following are merely some of the many probable-lie questions that have to be developed for specific issues. In the following examples of probable-lie questions, arranged by various categories of issues, the abbreviations have the following meanings: DYE (“Did you ever”); DY (“Do you”); DYRE (“Do you recall ever”); HYE (“Have you ever”).

FOR HOMICIDE:

1 HYE thought about hurting anyone?

2 HYE thought about hurting anyone physically?

3 DYRE wanting to see someone get hurt?

4 DYRE causing physical harm to anyone?

5 DYRE causing physical pain to anyone?

6 DYRE causing physical damage to someone?

7 DYRE wishing a person you knew would die?

8 DYRE thinking of killing someone and not do it?

9 DYRE thinking of how you would kill someone you knew?

10 HYE thought what it would be like to destroy someone?

11 HYE wanted to inflict pain on an enemy?

12 DYRE loosing your temper enough to seriously hurt someone?

13 DYRE wishing someone was dead?

FOR ROBBERY:

1 DYRE stealing anything of value?

2 DYRE deliberately hurting anyone?

3 DYRE threatening another person with any kind of weapon?

4 DYRE threatening anyone with physical harm?

5 DYRE thinking of robbing someone?

6 DYRE threatening anyone with any kind of weapon?

7 DYRE taking anything from anyone by force?

8 HYE forced anyone to do anything against their will?

9 HYE forced anyone to do anything they did not want to do?

10 HYE used anything as a weapon against another person?

11 DYRE doing something that would hurt someone?

12 DYRE causing physical harm to someone?

13 DYRE thinking it was right to use physical force to take what you wanted?

14 HYE threatened anyone physically, to get them to do something?

FOR VIOLENCE:

1 DID U EVER HURT ANYONE WEAKER THAN U?

2 WOULD ANYONE WHO KNOWS U THINK U ACTED AGRESSIVLY AT ANY TIME?

3 WOULD ANY GIRL U HAVE DATED IN THE PAST THINK U ACTED AGGRESSIVLY?

4 DYE TRY TO BULLY ANYONE?

5 DYE TRY TO INTIMIDATE SOMEONE?

6 DYE WISH HARM TO COME TO SOMEONE?

7 DYE WISH SOMEONE WAS DEAD?

8 DYE EVEN THINK ABOUT HURTING ANYONE?

9 DID U EVER PICK A FIGHT WITH ANYONE?

10 DYE WANT TO GET EVEN OR BACK AT SOMEONE?

11 DYE LIE ABOUT SOMEONE BEHIND THEIR BACK?

12 DYE HURT SOMEONE WHO TRUSTED U?

13 DYE LIE TO GET“EVEN”?

14 DYE THREATEN ANYONE?

15 DYE BLAME SOMEONE ELSE FOR SOMETHING U DID?

16 DYE EVEN THINK ABOUT USING A WEAPON?

17 DYE CAUSE A PROBLEM FOR ANYONE INTENTIONALLY?

18 DYE SPEAK DISRESPECTFULLY TO A BOSS OR SUPERVISOR?

19 DYE LOSE YOUR TEMPER?

20 DO U HAVE A PROBLEM CONTROLLING YOUR TEMPER?

21 DYE WANT TO SEE SOMEONE GET HURT?

22 DYE REMEMBER DOING ANYTHING THAT WOULD GET SOMEONE HURT?

23 DYE REMEMBER THINKING ABOUT WHAT IT WOULD BE LIKE TO KILL SOMEONE?

24 DYE THREATEN ANYONE WITH PHYSICAL HARM?

25 DY REMEMBER EVER WISHING ANY PERSON YOU KNEW WOULD DIE?

26 DYE DISTROY ANY PHYSICAL PROPERTY?

27 DY REMEMBER EVER STARTING AN ARGUMENT?

28 DY REMEMBER EVER STARTING A FIGHT?

29 DY REMEMBER EVER LYING ABOUT THE FACTS IN ANY ARGUMENT OR FIGHT?

30 DYE SAY ANYTHING ABOUT SOMEONE THAT WAS NOT TRUE?

31 DY REMEMBER LYING ABOUT ANYONE?

32 DY REMEMBER EVER DOING SOMETHING THAT WOULD HURT SOMEONE?

33 DY REMEMBER EVER THREATENING ANY ONE WITH PHYSICAL HARM?

FOR SEXUAL PROBABLE LIE COMPARISONS:

1 HYE TAKEN PART IN AN UNNATURAL SEX ACT?

2 ARE YOU THE TYPE OF PERSON THAT MASTERBATES?

3 BEFORE THE AGE OF _, DID YOU EVER DO SOMETHING THAT YOU ARE NOW ASHAMED OF?

4 DYRE IGNORING A WOMANS RESISTANCE TO SEX?

5 IS THERE ANY PART OF YOUR SEXUAL HISTORY YOU ARE ASHAMED OF?

6 IS THERE ANY PART OF YOUR SEXUAL HISTORY THAT YOU ARE HIDING FROM ME?

7 HYE THOUGHT OF COMMITTING ADULTERY?

8 HYE EXPOSED YOUR PENIS TO ANYONE?

9 DYR EVER WANTING TO HAVE SEX WITH ANY OTHER WOMAN THAN YOUR WIFE SINCE YOU WERE MARRIED?

10 DYRE TAKING PART IN AN ACT OF FORNICATION?

11 HAVE YOU EVER THOUGHT OF FORCING A WOMAN YOU KNEW TO HAVE SEX?

12 DYRE TAKING PART IN A 69 ACT WITH ANYONE?

13 DYRE WITNESSING A SEX ACT BETWEEN OTHER PEOPLE?

14 DYRE HAVING SEXUAL INTERESTS THAT WERE OTHER THAN NORMAL?

15 DYRE ENGAGING IN ANY UNUSUAL SEXUAL ACTIVITY?

16 DYRE DOING SOMETHING SEXUAL THAT OTHERS WOULD CONSIDER EXCESSIVE?

17 DYRE DOING ANY SEXUAL ACT THAT OTHERS WOULD CONSIDER ABNORMAL?

18 DYRE HAVING SEX WITH A STRANGER WHOSE NAME YOU DO NOT NOW RECALL?

19 DO YOU REMEMBER DOING SOMETHING SEXUAL BECAUSE YOU COULD NOT RESIST IT?

These are just a few examples of issues and subculture adaptations in designing polygraph comparison (“probable-lie”) questions.

The fourth step of the method of the present invention is, during the polygraph exam, selecting a sequence of question types from the first library, and selecting a first category of question types. The fifth step of the method of the present invention is reviewing a range of questions within the first category of question types. The first category could be the sub-culture, or could be the issue-at-hand. The sixth step of the method of the present invention is selecting and adding some of the questions within the first category to the selected sequence of question types. In the preferred embodiment of the present invention, a question is selected and added by simply highlighting the desired question in a list of questions, and then using a computer mouse to drag and drop the highlighted question into the selected sequence of question types.

The seventh step of the method of the present invention is selecting a second category. The eighth step of the method of the present invention is repeating the fifth and sixth steps for the second category. The ninth step of the method of the present invention is repeating the seventh and eighth steps until the polygraph examiner's question list is complete.

In some instances, the seventh through the ninth steps will be necessary only when the person being examined introduces unexpected information during the exam.

1. A method for improving the construction of a polygraph examiner's question list during a computerized polygraph exam includes the following steps:
a. before the polygraph exam, building a first digital library of different sequences of question types, and building a second digital library of different question types;
b. organizing the first and second libraries;
c. combining the different question types into multiple categories;
d. selecting a sequence of question types from the first library, and selecting at least a first category of question types;
e. reviewing a range of questions within the first category;
f. selecting and adding some of the questions within the first category to the selected sequence of question types;
g. during the polygraph exam, selecting at least a second category;
h. repeating steps (e) and (f) for the second category; and
i. repeating steps (g) and (h) until the polygraph examiner's question list is complete.

2. The method of claim 1, wherein the steps of selecting a second category and repeating the steps of reviewing, selecting, and adding, are performed during the polygraph exam only if unexpected information is learned during the polygraph exam.

3. The method of either of claim 1 or 2, wherein the sequences of question types comprise ARMYZONE, ARTHER, BZONE, MGQT, MGQTTHF, TESS, UTAH3-1, UTAH3-2, UTAH3-3, ZCT, ZONE COMPARISON, and ZONEYOU.

4. The method of claim 3, wherein the categories of question types comprise irrelevant, outside issue, relevant, and probable-lie questions.

5. The method of claim 4, wherein the probable-lie questions comprise categories of issues and categories of sub-cultures.

6. The method of claim 5, wherein the categories of issues for the probable-lie questions comprise discuss-general, employment, espionage, gang killings, general, homicide, lie, neutral-irrelevant, politics, rape, robbery, sexual improprieties, sex crimes, stealing, and violence.

7. The method of claim 6, wherein the categories of sub-cultures for the probable-lie questions comprise adulterers, corrupt politicians, drug users, embezzlers, ethnicity, gangs, maritime, pedophiles, politicians, rapists, sexual addicts, spies, and truckers.

8. The method of claim 7, wherein the step of selecting and adding some of the questions within the first category to the selected sequence of question types is done by highlighting on a computer screen the desired question in a list of questions, and then dragging and dropping the highlighted question into the selected sequence of question types.
